(19) United States
(12) Patent Application Publication
(10) Pub. No.: US 2003/0185652 A1
(43) Pub. Date: Oct. 2, 2003

(54) Fastener and fastener assembly for securing two objects together

(76) Inventor: Jung-Jyh Wu, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/107,265

(22) Filed: Mar. 28, 2002

(51) Int. Cl. F16B 19/00

(52) U.S. Cl. 411/508

(57) ABSTRACT

A fastener comprises a body having a first end for engaging with a first object. The body further includes a second end for engaging with a second object having an engaging hole. The second end of the body includes at least one resilient leg extending toward the first end of the body and spaced from the body. The resilient leg is pressable to allow the second end of the body to pass through the engaging hole of the second object. The second end of the body has a maximum width greater than a diameter of the engaging hole of the second object when the resilient leg is not pressed, thereby preventing disengagement of the second object from the second end of the body after assembly.

### BACKGROUND OF THE INVENTION

1. Field of the Invention

The present invention relates to a fastener for securing two objects together while allowing easy disengagement of the two objects. The present invention also relates to a fastener assembly for securing two objects that lie on two orthogonal planes.

2. Description of the Related Art

Two separate objects are generally secured together by fasteners such as rivets, bolts, and screws. Separation of the objects secured together by rivets, e.g., for replacement purpose, requires destruction of the rivets by an electric drill or the like. Namely, inconvenience exists when detaching the objects that are riveted together. The bolts and nuts or screws allow detachment of the objects. However, the assembling speed is low, and the objects could not rotate relative to each other after assembly. The present invention is intended to provide an improved fastener to solve these problems.

### SUMMARY OF THE INVENTION

An object of the present invention is to provide a fastener for securing two objects together while allowing easy disengagement of the two objects.

Another object of the present invention is to provide a fastener assembly for securing two objects that lie on two orthogonal planes.

In accordance with a first aspect of the invention, a fastener is provided and comprises a body having a first end for engaging with a first object. The body further includes a second end for engaging with a second object having an engaging hole. The second end of the body includes at least one resilient leg extending toward the first end of the body and spaced from the body. The resilient leg is pressable to allow the second end of the body to pass through the engaging hole of the second object. The second end of the body has a maximum width greater than a diameter of the engaging hole of the second object when the resilient leg is not pressed, thereby preventing disengagement of the second object from the second end of the body after assembly.

In accordance with a second aspect of the invention, a fastener assembly is provided and comprises a fastener and a mounting plate. The fastener includes a body having a first end and a second end for engaging with a first object having an engaging hole. The second end of the body includes at least one resilient leg extending toward the first end of the body and spaced from the body. The resilient leg is pressable to allow the second end of the body to pass through the engaging hole of the first object. The second end of the body has a maximum width greater than a diameter of the engaging hole of the first object when the resilient leg is not pressed, thereby preventing disengagement of the first object from the second end of the body after assembly.

The mounting plate includes a first section and a second section perpendicular to the first section. The first section includes an engaging hole for engaging with the first end of the body. The second section of the mounting plate is to be engaged with a second object.

The first end of the body includes a neck portion, leaving a distal engaging end on the first end of the body. The first object includes an engaging hole of the first section of the mounting plate allowing the distal engaging end of the body to pass therethrough until the neck portion is engaged in the engaging hole of the first section of the mounting plate, thereby securely engaging the first end of the body in the engaging hole of the first section of the mounting plate.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a fastener in accordance with the present invention.

FIG. 2 is a sectional view of the fastener and two objects secured together by the fastener.

FIG. 3 is a perspective view of a fastener assembly in accordance with the present invention.

FIG. 4 is a sectional view of the fastener assembly and two objects secured together by the fastener assembly.

### DETAILED DESCRIPTION OF THE PREFERRED EMBODIMENTS

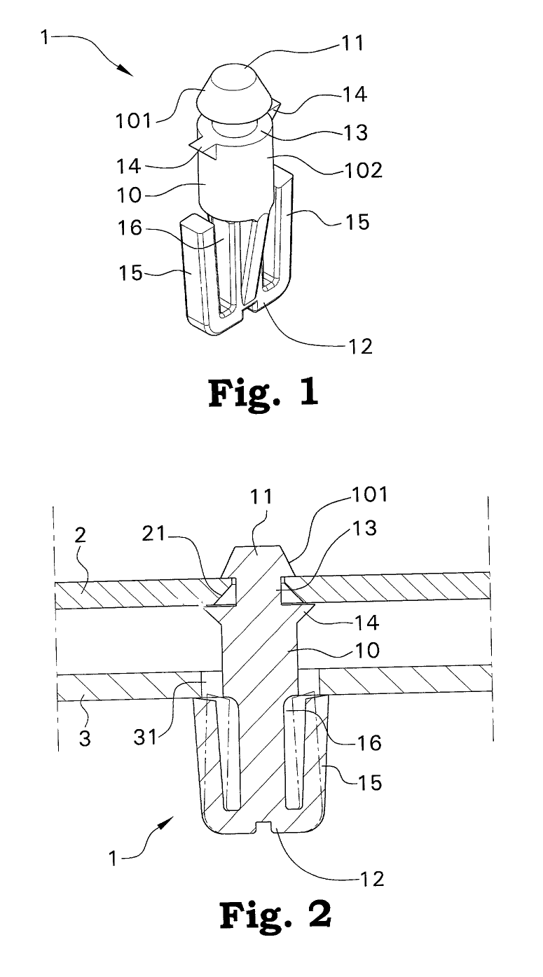

Referring to FIGS. 1 and 2, a fastener 1 in accordance with the present invention generally comprises a body 10 having a first end 11 for engaging with a first object 2 and a second end 12 for engaging with a second object 3. The first end 11 of the body 10 includes a neck portion 13, leaving a distal engaging end 101 that preferably has a conic face. At least one lug 14 (two in this embodiment) is formed on the first end 11 and adjacent to the necked portion 13.

The second end 12 of the body 10 includes at least one resilient leg 15 (two in this embodiment) projecting toward the first end 11 of the body but spaced from the body 10. Each resilient leg 15 is spaced from the body 10 by a space 16. Thus, each resilient leg 15 can be pressed inward to move toward the body 10, and the resilient leg 15 returns to its initial position after the pressing force is released.

As shown in FIG. 2, the fastener can be used for securing two parallel objects 2 and 3 together. The first object 2 includes an engaging hole 21 for engaging with the first end 11 of the fastener 1, and the second object 3 includes an engaging hole 23 for engaging with the second end 12 of the fastener 1. The first end 11 of the fastener 1 is forcibly passed through the engaging hole 21 of the first object 2 until the neck portion 13 is engaged in the engaging hole 21 of the second object 2. The lugs 14 prevent excessive movement of the first end 11 of the fastener 1. The engaging hole 21 of the first object 2 includes a conic section (not labeled) for guiding movement of the conic face of the distal engaging end 11 of the fastener 1.

The resilient legs 15 are pressed toward the body 10 (see the phantom lines in FIG. 2) and the second end 12 of the fastener 1 is passed through the engaging hole 31 of the second object 3 until the resilient legs 15 pass through the engaging hole 31. Then, the resilient legs 15 return to their initial positions after passing through the engaging hole 31. The maximum width of the second end 12 (including the resilient legs 15) of the fastener 1 in the initial position is greater than a diameter of the engaging hole 31 of the second object 31, best shown in FIG. 2. Thus, disengagement of the second end 12 of the fastener 1 from the second object 3 is prevented unless the resilient legs 15 are pressed and then moved in a reverse direction.

The first object 2 may be pivoted to a desired orientation relative to the second object 3 when desired. The second object 3 can be detached from the fastener 1 after assembly. The assembly and detachment operations can be accomplished in an easy, rapid manner.

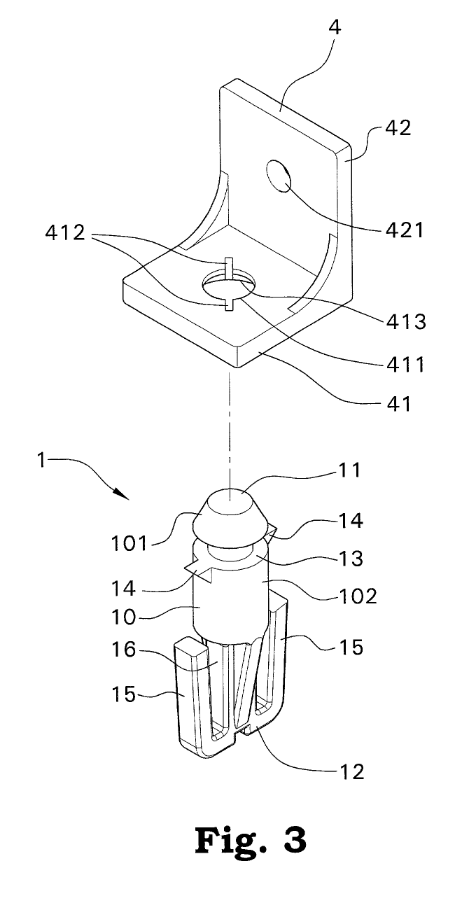

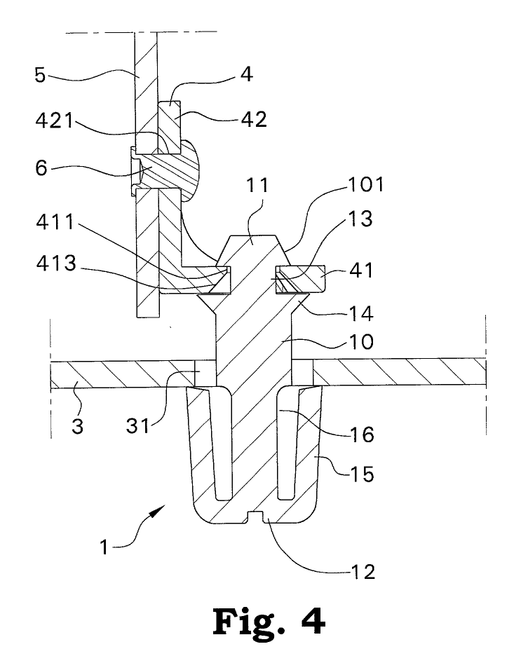

FIGS. 3 and 4 illustrate a fastener assembly in accordance with the present invention for securing two objects 3 and 5 that lie on two orthogonal planes. The fastener assembly in accordance with the present invention includes a fastener 1 and a mounting plate 4. The fastener 1 is identical to that of the first embodiment. The mounting plate 4 includes a first section 41 and a second section 42 perpendicular to the first section 41. The first section 41 includes an engaging hole 411, wherein two diametrically disposed slits 412 are defined in a periphery defining the engaging hole 411. Further, the engaging hole 411 includes a conic section 413 for guiding movement of the conic face of the distal engaging end 11 of the fastener 1. The second section 42 of the mounting plate 4 includes a hole 421.

Referring to FIG. 4, the second section 42 of the mounting plate 4 is attached to an object 5 by a rivet 6. The first end 11 of the fastener 1 is forcibly passed through the engaging hole 411 of the mounting plate 4 until the neck portion 13 is engaged in the engaging hole 411 of the mounting plate 4. The slits 412 allow easy passage of the distal engaging end 101 of the first end 11 of the body 10. The lugs 14 prevent excessive movement of the first end 11 of the fastener 1.

The resilient legs 15 are then pressed toward the body 10 and the second end 12 of the fastener 1 is passed through the engaging hole 31 of the object 3 until the resilient legs 15 pass through the engaging hole 31. Then, the resilient legs 15 return to their initial positions after passing through the engaging hole 31. The maximum width of the second end 12 (including the resilient legs 15) of the fastener 1 in the initial position is greater than a diameter of the engaging hole 31 of the second object 31, best shown in FIG. 4. Thus, disengagement of the second end 12 of the fastener 1 from the second object 3 is prevented unless the resilient legs 15 are pressed and then moved in a reverse direction.

The object 3 together with the fastener 1 may be pivoted to a desired orientation relative to the object 5 when desired. The object 3 can be detached from the fastener 1 after assembly. The assembly and detachment operations can be accomplished in an easy, rapid manner.

Although the invention has been explained in relation to its preferred embodiment, it is to be understood that many other possible modifications and variations can be made without departing from the scope of the invention as hereinafter claimed.

What is claimed is:

1. A fastener comprising a body having a first end for engaging with a first object, the body further including a second end for engaging with a second object having an engaging hole, the second end of the body including at least one resilient leg extending toward the first end of the body and spaced from the body, said at least one resilient leg being pressable to allow the second end of the body to pass through the engaging hole of the second object, the second end of the body having a maximum width greater than a diameter of the engaging hole of the second object when said at least one resilient leg is not pressed, thereby preventing disengagement of the second object from the second end of the body after assembly.

2. The fastener as claimed in claim 1, wherein the first end of the body includes a neck portion, leaving a distal engaging end on the first end of the body, the first object including an engaging hole allowing the distal engaging end of the body to pass therethrough until the neck portion is engaged in the engaging hole of the first object, thereby securely engaging the first end of the body in the engaging hole of the first object.

3. The fastener as claimed in claim 2, wherein the distal engaging end of the body includes a conic face.

4. The fastener as claimed in claim 2, wherein the body further includes at least one lug adjacent to the neck portion for preventing excessive movement of the first end of the body.

5. The fastener as claimed in claim 1, wherein a space is defined between the second end of the body and said at least one leg.

6. A fastener assembly comprising:
a fastener including a body having a first end and a second end for engaging with a first object having an engaging hole, the second end of the body including at least one resilient leg extending toward the first end of the body and spaced from the body, said at least one resilient leg being pressable to allow the second end of the body to pass through the engaging hole of the first object, the second end of the body having a maximum width greater than a diameter of the engaging hole of the first object when said at least one resilient leg is not pressed, thereby preventing disengagement of the first object from the second end of the body after assembly; and
a mounting plate including a first section and a second section perpendicular to the first section, the first section including an engaging hole for engaging with the first end of the body, the second section of the mounting plate being adapted to engage with a second object;
the first end of the body including a neck portion, leaving a distal engaging end on the first end of the body, the first object including an engaging hole of the first section of the mounting plate allowing the distal engaging end of the body to pass therethrough until the neck portion is engaged in the engaging hole of the first section of the mounting plate, thereby securely engaging the first end of the body in the engaging hole of the first section of the mounting plate.

7. The fastener as claimed in claim 6, wherein the distal engaging end of the body includes a conic face.

8. The fastener as claimed in claim 6, wherein the body further includes at least one lug adjacent to the neck portion for preventing excessive movement of the first end of the body.

9. The fastener as claimed in claim 6, wherein a space is defined between the second end of the body and said at least one leg.

10. The fastener as claimed in claim 6, wherein a periphery defining the engaging hole of the first section of the mounting plate includes two diametrically disposed slits.

11. The fastener as claimed in claim 6, wherein the engaging hole includes a conic section.
